(19) United States
(12) Patent Application Publication
(10) Pub. No.: US 2015/0277205 A1
(43) Pub. Date: Oct. 1, 2015

(54) WHITE PARTICLES FOR DISPLAY, PARTICLE DISPERSION FOR DISPLAY, AND DISPLAY DEVICE

(71) Applicant: FUJI XEROX CO., LTD., Tokyo (JP)

(72) Inventors: Jun KAWAHARA, Kanagawa (JP); Hiroshi KAYASHIMA, Kanagawa (JP)

(21) Appl. No.: 14/620,524

(22) Filed: Feb. 12, 2015

(30) Foreign Application Priority Data
Mar. 25, 2014 (JP) 2014-062457

(51) Int. Cl. G02F 1/167

(52) U.S. Cl. CPC G02F 1/167; G02F 2001/1678

(57) ABSTRACT

White particles for display, include inorganic white particles, and a covering layer that covers the inorganic white particles and includes a polymer obtained by polymerizing at least olefin as a constituent.

### CROSS-REFERENCE TO RELATED APPLICATIONS

This application is based on and claims priority under 35 USC 119 from Japanese Patent Application No. 2014-062457 filed Mar. 25, 2014.

### BACKGROUND

1. Technical Field

The present invention relates to white particles for display, a particle dispersion for display, and a display device.

2. Related Art

In the related art, as a display medium capable of rewriting repeatedly, a display medium using electrophoretic particles is known. The display medium, for example, includes a pair of substrates, and particles which are enclosed between the substrates according to an electric field formed between the pair of substrates such that the particles are able to be moved between the substrates. In addition, in the display medium, white particles may be enclosed between the substrates in order to display a white color.

### SUMMARY

According to an aspect of the invention, there are provided white particles for display, including:

inorganic white particles; and

a covering layer that covers the inorganic white particles and includes a polymer obtained by polymerizing at least olefin as a constituent.

### BRIEF DESCRIPTION OF THE DRAWINGS

Exemplary embodiments of the present invention will be described in detail based on the following figures, wherein:

FIG. 1 is a schematic configuration diagram of a display device according to this exemplary embodiment; and

FIGS. 2A and 2B are explanatory views schematically illustrating a movement aspect of a particle group when a voltage is applied between substrates of a display medium of a display device according to this exemplary embodiment.

### DETAILED DESCRIPTION

Hereinafter, the invention will be described in detail.

White Particles for Display

White particles for display according to this exemplary embodiment include inorganic white particles, and a covering layer covering the inorganic white particles. Then, the covering layer includes a polymer obtained by polymerizing at least olefin as a constituent.

Here, in the related art, when a background color is white in a display medium, it is preferable that white particles for display be maintained in a state of floating in a dispersion medium from a viewpoint of maintaining the white display.

However, inorganic white particles represented by titanium oxide particles or the like obtain display with a high whiteness index due to a high refraction index, but have high electric field responsiveness due to a large amount of charge, and thus a migration speed due to the electric field increases. As a result thereof, currently, mixed color display in which the inorganic white particles migrate to a display surface side of the display medium together with other colored electrophoretic particles (particles for display) is caused.

On the other hand, as the white particles for display, white particles in which inorganic particles are covered with a polymer of vinyl naphthalene are also known. The white particles which include the polymer of a monomer having a styrene skeleton represented by vinyl naphthalene or the like in a surface have a low charging property, and thus the electric field responsiveness thereof decreases.

However, in the white particles, decomposition of the polymer is progressed by light absorption of an aromatic ring of the polymer, and according to this decomposition, a polar group such as a ketone group may be created. In the surface of the white particles, when the polar group is created, the polar group is polarized, and the white particles have a charge, and thus the electric field responsiveness is expressed. Then, an absorption wavelength of light of the aromatic ring in the polymer of the monomer having the styrene skeleton, for example, is approximately 400 nm to an ultraviolet region, and even when an ultraviolet light cutting filter is disposed in the display medium, it is not possible to prevent the polymer from being decomposed. For this reason, the particles including the polymer of the monomer having the styrene skeleton in the surface also cause the mixed color display in which the particles migrate to the display surface side of the display medium together with the other colored electrophoretic particles (the particles for display) over time.

Further, when a cutting filter of a long wavelength region is used, a display quality is degraded due to coloration of the filter itself.

In contrast, in the white particles for display according to this exemplary embodiment, a surface of the inorganic white particles is covered with the covering layer in which the polymer having olefin as a polymerizable compound is included as a constituent. An absorption wavelength of light of the polymer having olefin as the polymerizable compound is approximately less than or equal to 350 nm at which the light is able to be cut by an ultraviolet light cutting filter. For this reason, expression of electric field responsiveness of the white particles for display decreases.

Furthermore, the polymer including olefin as the polymerizable compound is a material exhibiting a low charging property, and thus even when the inorganic white particles exhibit a high charging property, the electric field responsiveness decreases as the white particles for display. That is, a migration speed due to an electric field decreases.

As a result thereof, in a display medium (and a display device) to which the white particles for display according to this exemplary embodiment is applied, the white particles for display hardly migrate according to the electric field. That is, mixed color display due to the expression of the electric field responsiveness of the white particles for display is prevented.

Hereinafter, each component will be described.

Inorganic White Particles

As inorganic white particles, for example, metal oxide particles such as titanium oxide particles, silicon oxide particles, zinc oxide particles, and tin oxide particles are included. Among them, the titanium oxide particles are preferable from a viewpoint of obtaining display having a high refraction index and a high whiteness index.

The inorganic white particles may be subjected to a surface treatment with a hydrophobizing agent. As the hydrophobizing agent, a known agent such as a silane coupling agent is included.

Covering Layer

In a covering layer, a polymer having olefin as one of polymerizable compounds is included as a constituent. That is, the covering layer includes the polymer obtained by polymerizing at least olefin.

The polymer constituting the covering layer may be a polymer of olefin, or may be a copolymer of olefin and other polymerizable compounds. Furthermore, the polymer of olefin may be a polymer of one type of olefin, or may be a copolymer of two or more types of olefins, and it is especially preferably that alicyclic olefin be copolymerized.

Olefin

As olefin, straight chain aliphatic olefin or branched aliphatic olefin, and alicyclic olefin are included.

As straight chain aliphatic olefin or branched aliphatic olefin, aliphatic olefin having from 2 to 18 carbon atoms (preferably having from 2 to 12 carbon atoms) is included. Specifically, as aliphatic olefin, for example, α-olefin such as ethylene, propylene, 1-butene, 1-hexene, 4-methyl-1-pentene, 1-octene, 1-decene, 1-hexadecene, and 1-octadecene is included.

As alicyclic olefin, alicyclic olefin having from 4 to 8 carbon atoms (preferably having from 4 to 6 carbon atoms) is included. Specifically, as alicyclic olefin, for example, cyclopentene, cycloheptene, norbornene, 5-methyl-2-norbornene, tetracyclododecene, vinyl cyclohexane, and the like are included.

Furthermore, one type of olefin may be independently used, or two or more types of olefins may be used in combination.

As a polymer (a polyolefin) including olefin as one of the polymerizable compounds, a cycloolefin polymer and a cycloolefin copolymer are especially preferable in terms of a decrease in expression of electric field responsiveness, availability, or the like. As a specific cycloolefin polymer, ZEONOR 1020R, ZEONOR 1060R, ZEONEX 480, ZEONEX 480R, ZEONEX E48R, ZEONEX F52R, ZEONEX 330R, ZEONEX RS420 (manufactured by Nippon Zeon Co., Ltd.), and the like are included. As a specific cycloolefin copolymer, TOPAS 5013L-10, TOPAS 6013EC-01, TOPAS 6013F-04, TOPAS 6013L-17, TOPAS 6013M-07, TOPAS 6013S-04, TOPAS 6015S-04, TOPAS 6017S-04, TOPAS 8007F-04, TOPAS 8007F-500, TOPAS 8007S-04, TOPAS 9506F-04, TOPAS 9506E-500 (manufactured by Polyplastics Co., Ltd.), and the like are included.

Next, other aspects of the white particles for display will be described.

A surface of the white particles for display may be covered with or attached with a silicone polymer dispersant in terms of increasing dispersibility in a dispersion medium. That is, a surface of the covering layer may be covered with or attached with a silicone polymer dispersant.

As the silicone polymer dispersant, there is a high-molecular compound having a silicone chain. As the silicone polymer dispersant, a polymer in which a polymerizable compound having at least a silicone chain is polymerized is included. The silicone polymer dispersant exists in the surface of the white particles for display (the surface of the covering layer is covered with or attached with the silicone polymer dispersant), and thus dispersibility of the white particles for display increases.

The silicone polymer dispersant may be a copolymer of a polymerizable compound having a silicone chain and other polymerizable compounds. As the other polymerizable compound which is able to be copolymerized with the polymerizable compound having the silicone chain, for example, a polymerizable compound not having a reactive group (a cross-linking group) and a polymerizable compound having a reactive group (a cross-linking group) are included. In particular, when the polymerizable compound having the reactive group is used as the other polymerizable compound, the surface of the white particles (the surface of the covering layer thereof) is attached with or covered with the silicone polymer dispersant in a state where a polymer itself is cross-linked.

Polymerizable Compound Having Silicone Chain

As the polymerizable compound having the silicone chain, a known compound such as a straight chain silicone compound and a branched silicone compound is included. In particular, when the branched silicone compound is applied, it is preferable in terms of easily preventing adhering of the white particles for display.

Furthermore, as the polymerizable compound having the silicone chain, a monomer may be used, or a macromonomer may be used. The “macromonomer” is a general term for an oligomer having a polymerizable functional group (a polymerization degree approximately from 2 to 300) or a polymer, and has both properties of a polymer and a monomer. In addition, the polymerizable compound having the silicone chain may be independently used, or plural polymerizable compounds having a silicone chain may be used in combination.

As the straight chain silicone compound, for example, a dimethyl silicone compound having a (meth)acrylate group on one terminal (A silicone compound represented by the following formula (1). For example, Silaplane: FM-0711, FM-0721, FM-0725, and the like manufactured by JNC Co., Ltd., and X-22-174DX, X-22-2426, X-22-2475, and the like manufactured by Shin-Etsu Chemical Co., Ltd.) is included.

As the branched silicone compound, for example, a silicone compound represented by the following formulas (2) to (7), and the like are included.

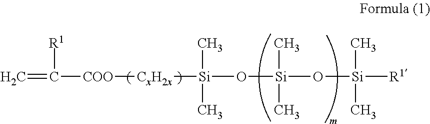

In the formula (1), R¹ represents a hydrogen atom or a methyl group. R^{1′} represents a hydrogen atom or an alkyl group having from 1 to 4 carbon atoms. m represents a natural number (for example, from 1 to 1000, and preferably from 3 to 100). x represents an integer from 1 to 3.

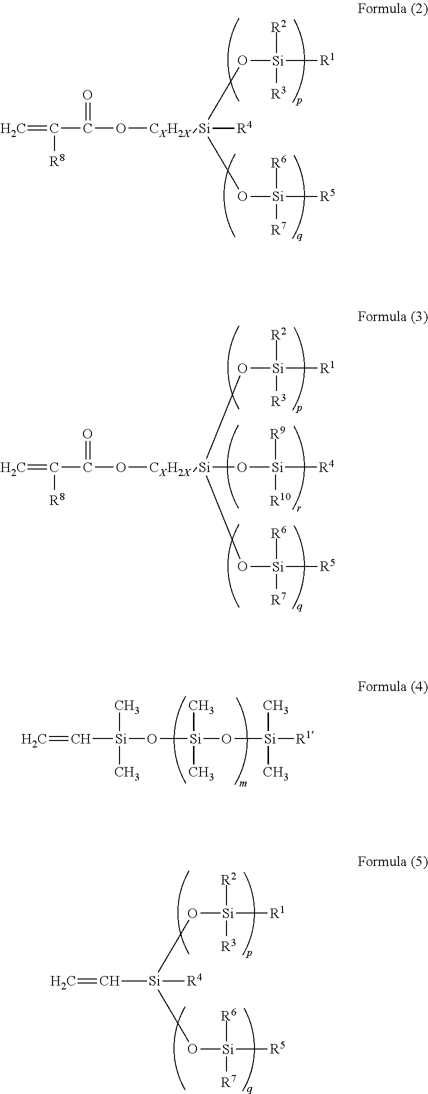

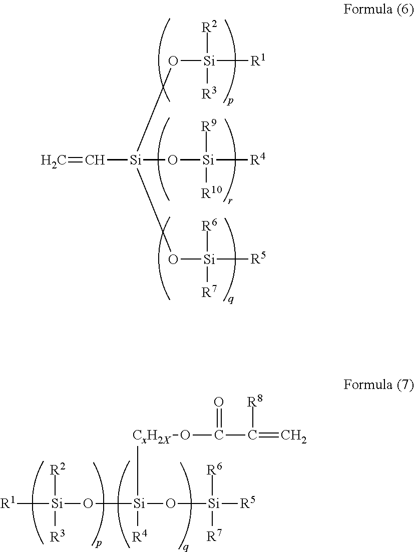

In the formulas (2), (3), (5), (6), and (7), R¹, R², R³, R⁴, R⁵, R⁶, R⁷, R⁹, and R¹⁰ each independently represents a hydrogen atom, an alkyl group having from 1 to 4 carbon atoms, or a fluoroalkyl group having from 1 to 4 carbon atoms. R⁸ represents a hydrogen atom or a methyl group. p, q, and r each independently represents an integer from 1 to 1000. x represents an integer from 1 to 3.

In the formula (4), R^{1′} represents a hydrogen atom or an alkyl group having from 1 to 4 carbon atoms. m represents a natural number (for example, from 1 to 1000, and preferably from 3 to 100). x represents an integer from 1 to 3.

For the silicone compound represented by the formulas (2) and (5), an aspect is preferable in which R¹ and R⁵ are a butyl group, R², R³, R⁴, R⁶, and R⁷ are a methyl group, R⁸ is a methyl group, p and q are each independently an integer from 1 to 5, and x is an integer from 1 to 3.

For the silicone compound represented by the formulas (3) and (6), an aspect is preferable in which R¹, R², R³, R⁴, R⁵, R⁶, R⁷, R⁹, and R¹⁰ are a methyl group, R⁸ is a hydrogen atom or a methyl group, p, q, and r are each independently an integer from 1 to 3, and x is an integer from 1 to 3.

For the silicone compound represented by the formula (7), an aspect is preferable in which R¹, R², R³, R⁴, R⁵, R⁶, R⁷, R⁹, and R¹⁰ are a methyl group, R⁸ is a hydrogen atom or a methyl group, p and q are each independently an integer from 1 to 5, and x is an integer from 1 to 3.

As the silicone compound represented by the formula (2), for example, MCS-M11 and MFS-M15 manufactured by Gelest Inc., and the like are included. As the silicone compound represented by the formula (3), for example, RTT-1011 manufactured by Gelest Inc., X22-2404 manufactured by Shin-Etsu Chemical Co., Ltd., and the like are included. As the silicone compound represented by the formula (4), for example, MCR-V21 manufactured by Gelest Inc., and the like are included. As the silicone compound represented by the formula (5), for example, MCS-V12 manufactured by Gelest Inc., and the like are included. As the silicone compound represented by the formula (6), for example, VTT-106 manufactured by Gelest Inc., and the like are included. As the silicone compound represented by the formula (7), for example, RMS-044, RMS-033, and RMS-083 manufactured by Gelest Inc., and the like are included. A representative formula of these silicone compounds is as follows.

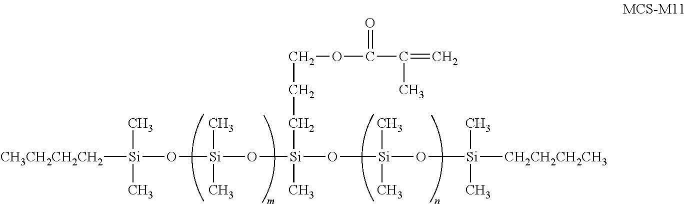

As to MCS-M11, m and n are each independently an integer from 2 to 4 in the formula described above, and molecular weight thereof is from 800 to 1000.

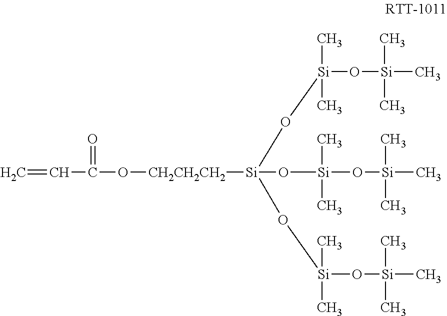

RTT-1011 is a compound represented by the formula described above.

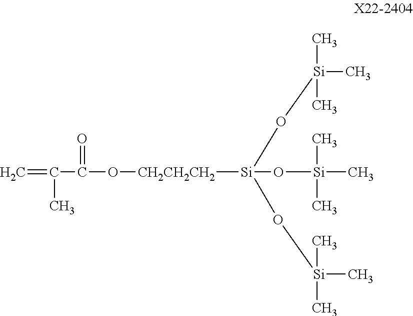

X22-2404 is a compound represented by the formula described above.

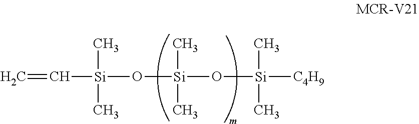

As to MCR-V21, m is an integer from 72 to 85 in the formula described above, and molecular weight thereof is from 5500 to 6500.

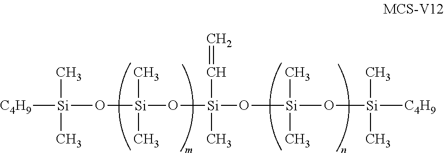

As to MCS-V12, m and n are an integer from 6 to 10 in the formula described above, and molecular weight thereof is from 1200 to 1400.

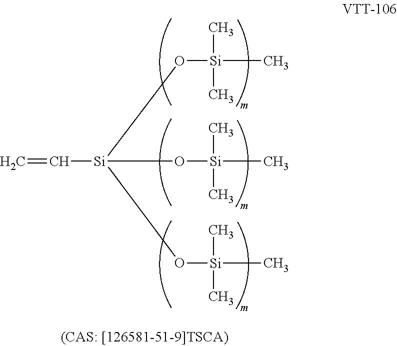

VTT-106 is a compound represented by the formula described above.

Polymerizable Compound Not Having Reactive Group (Cross-Linking Group)

The polymerizable compound not having the reactive group (the cross-linking group) is not particularly limited insofar as it is a general polymerizable compound, and as the polymerizable compound not having the reactive group (the cross-linking group), for example, styrene, vinyl naphthalene, vinyl biphenyl, methyl (meth)acrylate, butyl (meth)acrylate, hexyl (meth)acrylate, octyl (meth)acrylate, dodecyl (meth) acrylate, stearyl (meth) acrylate, 2-ethylhexyl (meth)acrylate, and the like are included.

As the polymerizable compound not having the reactive group (the cross-linking group), (meth)acrylonitrile, (meth)acrylic acid alkyl ester, (meth)acrylamide, N-dialkyl-substituted (meth)acrylamide, vinyl carbazole, vinyl chloride, vinylidene chloride, isoprene, butadiene, vinyl pyrrolidone, and the like are also included.

Furthermore, “(meth)acryl” indicates both “acryl and methacryl”, “(meth)acrylo” indicates both “acrylo and methacrylo”, and “(meth)acrylate” indicates both “acrylate and methacrylate”.

Polymerizable Compound Having Reactive Group (Cross-Linking Group)

As the polymerizable compound having the reactive group (the cross-linking group), for example, glycidyl (meth)acrylate having an epoxy group, an isocyanate monomer having an isocyanate group (for example, Karenz AOI (2-isocyanate ethyl acrylate) and Karenz MOI (2-isocyanate ethyl methacrylate) manufactured by Showa Denko), an isocyanate monomer having a blocked isocyanate group (for example, Karenz MOI-BM (methacrylic acid 2-(0-[1′-methylpropylidene amino]carboxyamino)ethyl) and Karenz MOI-BP (2-[(3,5-dimethyl pyrazolyl)carbonylamino]ethyl methacrylate) manufactured by Showa Denko), and the like are included.

Furthermore, the blocked isocyanate group, for example, is in a state where an isocyanate group is reacted with a substituent group, and is in a state where an isocyanate group is reacted with a substituent group to be detached by heating. Accordingly, reactivity of the isocyanate group is prevented, and thus the isocyanate group is in a state of being reacted with the substituent group when the substituent group is detached by heating.

In the silicone polymer dispersant, the polymerizable compound having the silicone chain may be from 10% by weight to 90% by weight (preferably, from 20% by weight to 80% by weight) with respect to the entire polymer.

Weight-average molecular weight of the silicone polymer dispersant is preferably from 20000 to 100000, and is more preferably from 30000 to 60000.

The weight-average molecular weight is a value measured by a gel permeation chromatography (GPC). The same applies hereinafter.

Next, a property of the white particles for display will be described.

A volume average particle diameter of the white particles for display, for example, may be from 0.1 μm to 10 μm, may be preferably from 0.15 μm to 5 μm, and may be more preferably from 0.15 μm to 1 μm.

Furthermore, the volume average particle diameter of the particles is a value measured by “FPAR-1000: a particle diameter analyzer” manufactured by Otsuka Electronics Co., Ltd.

In the white particles for display, a covering amount of the covering layer with respect to the inorganic white particles, for example, may be from 1% by weight to 99% by weight, and is preferably from 5% by weight to 80% by weight with respect to weight of the inorganic white particles.

The covering amount of the covering layer, for example, is obtained as follows. As one method, prepared white particles for display are subjected to centrifugal settling, and weight of the settled white particles for display is measured, and thus the covering amount is calculated as an increased amount with respect to the weight of the inorganic white particles material. As other methods, the covering amount may be calculated by a composition analysis for particles and a thermogravimetric analysis.

Next, a manufacturing method of the white particles for display will be described.

As an example of the manufacturing method of the white particles for display, for example, the following coacervation method is included, but the manufacturing method is not limited thereto.

First, a polymer obtained by polymerizing at least olefin, and inorganic white particles are mixed in a first solvent, and a mixed liquid in which the polymer is dissolved is prepared.

Here, the first solvent is a good solvent which is able to form a dispersed phase in a second solvent (a poor solvent which is able to forma continuous phase) described above, has a boiling point lower than that of the second solvent, and is selected from solvents in which the polymer is dissolved. As the first solvent, for example, water, isopropyl alcohol (IPA), methanol, ethanol, butanol, tetrahydrofuran (THF), ethyl acetate, butyl acetate, and the like are included.

Next, the obtained mixed liquid is mixed with the second solvent in which the polymer is not able to be dissolved, is stirred, and is emulsified by using the second solvent as a continuous phase, and thus the polymer is precipitated on the surface of the inorganic white particles.

Then, the first solvent in the emulsified liquid is removed (dried) by heating or the like, and thus a dispersion where the white particles for display in which the surface of the inorganic white particles is covered with the polymer are dispersed in the second solvent is obtained.

Here, the second solvent is a poor solvent which is able to form the continuous phase with respect to the first solvent which becomes the dispersed phase, has a boiling point higher than that of the first solvent, and is selected from solvents in which the polymer is not able to be dissolved. As the second solvent, for example, a dispersion medium for dispersing the obtained white particles for display is included.

Particle Dispersion for Display

The particle dispersion for display according to this exemplary embodiment includes a white particle group including the white particles for display according to this exemplary embodiment, and a dispersion medium for dispersing the white particle group.

Furthermore, in the particle dispersion for display, an electrophoretic particle group including electrophoretic particles that migrate according to an electric field may be further included. In addition, as necessary, in the particle dispersion for display, other known additives such as a charge-controlling agent may be included.

Electrophoretic Particles

As the electrophoretic particles, known particles migrating in the dispersion medium according to the electric field are included.

For example, as the electrophoretic particles, for example, resin particles, particles in which a colorant is adhered to a surface of resin particles, particles containing a colorant in a resin, and the like are included. In addition, as the electrophoretic particles, insulating metal oxide particles (for example, particles such as glass beads, alumina, and titanium oxide), metallic colloid particles having a plasmon coloring function, and the like are included.

As a thermoplastic resin used for the electrophoretic particles, for example, a resin formed of a homopolymer of styrenes such as styrene and chlorostyrene; monoolefin such as ethylene, propylene, butylene, and isoprene; vinyl esters such as vinyl acetate, vinyl propionate, vinyl benzoate, and vinyl butyrate; a-methylene aliphatic monocarboxylic acid esters such as methyl acrylate, ethyl acrylate, butyl acrylate, dodecyl acrylate, octyl acrylate, phenyl acrylate, methyl methacrylate, ethyl methacrylate, butyl methacrylate, and dodecyl methacrylate; vinyl ethers such as vinyl methyl ether, vinyl ethyl ether, and vinyl butyl ether; vinyl ketones such as vinyl methyl ketone, vinyl hexyl ketone, and vinyl isopropenyl ketone, or a copolymer thereof is included.

As a thermosetting resin used for the electrophoretic particles, for example, a cross-linked resin such as a cross-linked copolymer including divinylbenzene as a main component or a cross-linked polymethyl methacrylate, a phenol resin, an urea resins, a melamine resin, a polyester resin, a silicone resins, and the like are included.

As a representative resin used for the electrophoretic particles, for example, a polystyrene resins, a styrene-alkyl acrylate copolymer, a styrene-alkyl methacrylate copolymer, a styrene-acrylonitrile copolymer, a styrene-butadiene copolymer, a styrene-maleic anhydride copolymer, a polyethylene resin, a polypropylene resin, a polyester resin, a polyurethane resin, an epoxy resin, a silicone resin, a polyamide resin, modified rosin, paraffin wax, and the like are included.

As the colorant used for the electrophoretic particles, an organic or an inorganic pigment, an oil soluble dye, and the like are included.

As the colorant, for example, a known colorant such as a magnetic powder such as magnetite and ferrite, carbon black, titanium oxide, magnesium oxide, zinc oxide, a copper phthalocyanine cyan colorant, an azo yellow colorant, an azo magenta colorant, a quinacridone magenta colorant, a red colorant, a green colorant, and a blue colorant is included.

Specifically, as the colorant, for example, aniline blue, calco oil blue, chrome yellow, ultramarine blue, Dupont oil red, quinoline yellow, methylene blue chloride, phthalocyanine blue, malachite green oxalate, lamp black, rose bengal, C.I. Pigment Red 48:1, C.I. Pigment Red 122, C.I. Pigment Red 57:1, C.I. Pigment Yellow 97, C. Blue 15:1, C.I. Pigment Blue 15:3, and the like are representative.

A content of the colorant, for example, may be from 10% by weight to 99% by weight with respect to a resin configuring the electrophoretic particles, and preferably from 30% by weight to 80% by weight.

In the electrophoretic particles, as necessary, a charge-controlling agent may be included. As the charge-controlling agent, a known charge-controlling agent used for an electrophotographic toner material is included, for example, cetyl pyridyl chloride, a quaternary ammonium salt such as BONTRON P-51, BONTRON P-53, BONTRON E-84, and BONTRON E-81 (manufactured by Orient Chemical Industries, Ltd.), a salicylic acid metal complex, a phenolic condensate, a tetra phenyl compound, metal oxide particles, metal oxide particles subjected to a surface-treatment by various coupling agents.

A surface of the electrophoretic particles may be subjected to a surface treatment by the silicone compound having the reactive group. That is, the electrophoretic particles may be particles having a core-shell structure in which the electrophoretic particles are core particles, and a covering layer of a silicone compound is provided on a surface of the core particles.

Furthermore, in a case of the particles having the core-shell structure, the core particles may preferably include a resin having a reactive group which is reacted with a reactive group of a silicone compound (for example, a hydroxyl group, a carboxyl group, a carbonyl group, an amino group, and the like). As the resin having such a reactive group, for example, a melamine resin, a guanamine resin, a styrene-acrylic acid copolymer, a styrene-methacrylic acid copolymer, a styrene-maleic anhydride copolymer, a polyvinyl alcohol resin, a polyvinyl butyral resin, gelatin, agar, and the like are preferably included.

In addition, when the silicone compound has a charging group, the core particles may include a resin not having a charging group.

As necessary, an external additive may be attached to the surface of the electrophoretic particles. It is preferable that a color of the external additive be transparent in order not to influence a color of the electrophoretic particles.

As the external additive, inorganic particles of metal oxide or the like such as silicon oxide (silica), titanium oxide, and alumina are included. The external additive may be subjected to a surface treatment by a coupling agent or silicone oil in order to adjust a charging property, fluidity, environmental dependency, or the like of the electrophoretic particles.

As the coupling agent, a coupling agent having a positive charging property such as an aminosilane coupling agent, an amino-titanium coupling agent, and a nitrile coupling agent, and a coupling agent having a negative charging property such as a silane coupling agent not containing a nitrogen atom (configured by atoms other than the nitrogen atom), a titanium coupling agent, an epoxy silane coupling agent, and an acrylic silane coupling agent are included.

As the silicone oil, silicone oil having a positive charging property such as amino-modified silicone oil, and silicone oil having a negative charging property such as dimethyl silicone oil, alkyl-modified silicone oil, a-methyl sulfone-modified silicone oil, methylphenyl silicone oil, chlorophenyl silicone oil, and fluorine-modified silicone oil are included.

Furthermore, the coupling agent or the silicone oil is selected according to desired resistance of the external additive.

A diameter of primary particles of the external additive, for example, may be from 1 nm to 100 nm, and is preferably from 5 nm to 50 nm, but the diameter is not limited thereto.

An externally added amount of the external additive, for example, may be from 0.01 parts by weight to 3 parts by weight with respect to 100 parts by weight of the electrophoretic particles, and is preferably from 0.05 parts by weight to 1 part by weight.

The externally added amount of the external additive may preferably be adjusted from a balance between a particle diameter of the electrophoretic particles and a particle diameter of the external additive. Then, when the externally added amount of the external additive is within the range described above, at least a part of the external additive is isolated from the surface of the electrophoretic particles, and the isolated part of the external additive is attached to the surface of the other electrophoretic particles, and thus it is preferable that a desired charge property is easily prevented from being lost.

The external additive may be added to any one of plural types of electrophoretic particles, or the external additive may be added to plural types or entire types of electrophoretic particles. When the external additive is added to the surface of the entire electrophoretic particles, the external additive may be implanted on the surface of the electrophoretic particles with an impact force, or the external additive may be solidly adhered to the surface of the electrophoretic particles by heating the surface of the electrophoretic particles. Accordingly, isolation of the external additive from the electrophoretic particles, solid aggregation of the external additive having heteropolarity, and formation of an aggregate of the external additive which is hardly disaggregated in the electric field are prevented from occurring, and thus it is preferable that image deterioration is easily prevented.

A volume average particle diameter of the electrophoretic particles, for example, may be from 0.05 μm to 20 μm, and is preferably from 0.1 μm to 10 μm. Furthermore, a size of the electrophoretic particles is not particularly limited, and a preferable range thereof is determined according to an intended purpose.

As a manufacturing method of the electrophoretic particles, any known method of the related art may be used. Specifically, for example, the following methods are included.

1) As disclosed in JP-A-7-325434, a method of manufacturing electrophoretic particles by weighing a resin, a pigment, and a charge-controlling agent as necessary so as to be in an intended mixing ratio, by adding the pigment to the resin after heating and melting the resin, by mixing the pigment and the resin, and by dispersing and cooling the mixture, then by pulverizing the mixture using a pulverizer such as a jet mill, a hammer mill, and a turbo mill.

2) A method of manufacturing electrophoretic particles by using a polymerization method such as suspension polymerization, emulsion polymerization, and dispersion polymerization, or coacervation, melt dispersion, and an emulsion aggregation method.

3) A method of manufacturing particles by dispersing and kneading a raw material of a resin, a colorant, a dispersion medium, and a charge-controlling agent as necessary at a temperature lower than a decomposition point of at least one of the resin, the colorant, and the charge-controlling agent as necessary without boiling the dispersion medium when a resin has plasticity (specifically, a method of manufacturing electrophoretic particles by heating and melting the resin, the colorant, and the charge-controlling agent as necessary in the dispersion medium, for example, using meteor type mixer, a kneader, or the like, by cooling the melted mixture using temperature dependency of solubility in solvent of the resin while stirring the mixture, and by solidifying and precipitating the mixture).

4) A method of preparing particles by inputting the raw material described above into a suitable container in which granular media for dispersing and kneading are equipped, for example, an attritor and a heated oscillating mill such as a heated ball mill, and by dispersing and kneading the raw material in the container at a preferable temperature range, for example, from 80° C. to 160° C.

Furthermore, as the granular media, for example, steel such as stainless steel and carbon steel, alumina, zirconia, silica, and the like are preferably used. In order to manufacture the electrophoretic particles by a method using the granular media, it is preferable that the raw material which is in a fluidized state in advance may be further dispersed in the container by the granular media, then the dispersion medium may be cooled, and the resin including the colorant may be precipitated from the dispersion medium. It is preferable that the granular media may generate shear and impact while continuously maintaining a motional state even in the cooling and even after the cooling, and may reduce a particle diameter of the obtained electrophoretic particles.

Dispersion Medium

As the dispersion medium, various dispersion media used for the display medium are applied, and, preferably, a low dielectric solvent (for example, a dielectric constant less than or equal to 5.0, and preferably less than or equal to 3.0) may be selected. For the dispersion medium, a solvent other than the low dielectric solvent may be used in combination, and the low dielectric solvent may be included, preferably, greater than or equal to 50% by volume. Furthermore, the dielectric constant of the low dielectric solvent is obtained by a dielectric constant meter (manufactured by Japan Rufuto Co., Ltd.).

As the low dielectric solvent, for example, a petroleum-derived high-boiling solvent such as a paraffin hydrocarbon solvent, silicone oil, and a fluorine liquid is included, and the low dielectric solvent may be selected preferably according to a type of copolymer configuring the particles.

Specifically, for example, when a reactive compound having a silicone chain is applied as a specific reactive compound, the silicone oil may be selected preferably as the dispersion medium. In addition, when a reactive compound having an alkyl chain is applied as a specific reactive compound, the paraffin hydrocarbon solvent may be selected preferably as the dispersion medium. Obviously, the low dielectric solvent is not limited thereto.

Specifically, as the silicone oil, silicone oil in which a hydrocarbon group is bonded to a siloxane bond (for example, dimethyl silicone oil, diethyl silicone oil, methyl ethyl silicone oil, methylphenyl silicone oil, diphenyl silicone oil, and the like) is included. Among them, dimethyl silicone is especially preferable.

As the paraffin hydrocarbon solvent, normal paraffin hydrocarbon having carbon atoms greater than or equal to 20 (a boiling point greater than or equal to 80° C.), and isoparaffin hydrocarbon are included, and isoparaffin hydrocarbon is preferably used in terms of safety, volatility, or the like. Specifically, Shellsol 71 (manufactured by Shell Petroleum Company), Isopar O, Isopar H, Isopar K, Isopar L, Isopar G, Isopar M (“Isopar” is a trade name of Exxon, Inc.), and IP Solvent (manufactured by Idemitsu Kosan CO., Ltd.) are included.

Charge-Controlling Agent

As the charge-controlling agent, anionic or a nonionic surfactant agent, a block or a graft copolymers formed of a lipophilic portion and a hydrophilic portion, a compound having a polymer chain skeleton such as an annular, an asteroid, or an arboroid polymer (a dendrimer), a metal complex of salicylic acid, a metal complex of catechol, a metal-containing bisazo dye, tetraphenylborate derivatives, a copolymer of a polymerizable silicone macromer (Silaplane manufactured by JNC Co., Ltd.) and an anionic monomer or a cationic polymer, and the like are included.

More specifically, the ionic surfactant agent and the nonionic surfactant agent are as follows. As the nonionic surfactant agent, polyoxyethylene nonyl phenyl ether, polyoxyethylene octyl phenyl ether, polyoxyethylene dodecyl phenyl ether, polyoxyethylene alkyl ether, polyoxyethylene fatty acid ester, sorbitan fatty acid ester, polyoxyethylene sorbitan fatty acid ester, fatty acid alkylolamide, and the like are included. As the anionic surfactant agent, alkyl benzene sulfonate, alkyl phenyl sulfonate, alkyl naphthalene sulfonate, a higher fatty acid salt, a sulfuric acid ester salt of higher fatty acid ester, sulfonic acid of higher fatty acid ester, and the like are included. As a cationic surfactant agent, a primary to a tertiary amine salts, a quaternary ammonium salt, and the like are included.

An amount of the charge-controlling agent to be used is preferably from 0.01% by weight to 20% by weight with respect to a solid content of the particles, and is especially preferably from 0.05% by weight to 10% by weight.

Known Additive

As the known additive, acid, alkali, salt, dispersant, a dispersion stabilizer, a stabilizer, an antimicrobial agent, a preservative, and the like are included.

Others

A concentration of the electrophoretic particles is not particularly limited insofar as it is able to obtain an intended display color, and for example, may preferably be from 0.01% by weight to 50% by weight.

Furthermore, the concentration of the electrophoretic particles may preferably be in the range described above as a concentration in the particle dispersion for display which is in a state of being enclosed between the pair of substrates (or electrodes, the same applies hereinafter) of the display device. In addition, it is effective that the concentration of the electrophoretic particles is adjusted by a distance between the pair of substrates of the display device. In order to obtain an intended color phase, the concentration of the particles decreases as the distance between the pair of substrates of the display device increases, and the concentration of the particles increases as the distance decreases.

A concentration of the white particles for display, for example, may be from 1% by volume to 50% by volume, and is preferably from 2% by volume to 30% by volume.

When the concentration of the white particles for display is within the range described above, it is effective in that a reflection rate of color display of the white particles for display increases, and an increase in viscosity of the dispersion medium due to dispersion of the white particles for display is prevented, and thus a decrease in a driving property (for example, display responsiveness) due to electrophoretic particles is easily prevented.

Furthermore, the concentration of the white particles for display may be in the range described above as a concentration in the particle dispersion for display in a state of being enclosed between the pair of substrates (or electrodes, the same applies hereinafter) of the display device. In addition, it is effective that the concentration of the white particles for display is adjusted by a distance between the pair of substrates of the image display device. In order to obtain an intended color phase, the concentration of the particles decreases as the distance between the pair of substrates of the display device increases, and the concentration of the particles increases as the distance decreases.

The dispersion for display according to this exemplary embodiment may include a particle group and a dispersion in a capsule. That is, the dispersion for display according to this exemplary embodiment may include an aspect in which the dispersion for display is arranged between the substrates (or the electrodes) of the display device (the display medium) as capsule particles.

Intended Purpose of White Particles for Display and Particle Dispersion for Display Using The Same

The white particles for display (and the particle dispersion for display) according to this exemplary embodiment are used for an electrophoretic display medium (including an electrophoretic light control medium (a light control element)). Furthermore, as the electrophoretic display medium, an electrophoretic display medium in which a particle group is moved in a facing direction of a known electrode (a known substrate) surface, and contrary to this, an electrophoretic display medium in which the particle group is moved in a direction along the electrode (the substrate) surface (a so-called in-plane type element), or a hybrid element of a combination thereof are included.

Furthermore, in the particle dispersion for display according to this exemplary embodiment, when plural types of particles having a different color or charging polarity are used by being mixed as the electrophoretic particles which are moved according to the electric field, the color display is obtained.

Electrophoretic Display Medium and Electrophoretic Display Device

Hereinafter, an exemplary embodiment which is an example of the display medium and the display device of the invention will be described with reference to the drawings.

The display medium according to this exemplary embodiment may have a pair of substrates at least one of which has translucency, an electrophoretic particle group that is enclosed between the pair of substrates, and includes electrophoretic particles that migrate according to an electric field, a white particle group that is enclosed between the pair of substrates, and includes the white particles for display according to the exemplary embodiment, and a dispersion medium that is enclosed between the pair of substrates, and disperses the electrophoretic particle group and the white particle group.

The display medium of this exemplary embodiment may also have a pair of electrodes at least one of which has translucency, an electrophoretic particle group that is enclosed between the pair of electrodes, and includes electrophoretic particles that migrate according to an electric field, a white particle group that is enclosed between the pair of electrodes, and includes the white particles for display according to the exemplary embodiment, and a dispersion medium that is enclosed between the pair of electrodes, and disperses the electrophoretic particle group and the white particle group.

The display device of this exemplary embodiment may have the display medium according to the exemplary embodiment, and an electric field forming unit that forms an electric field between the pair of substrates.

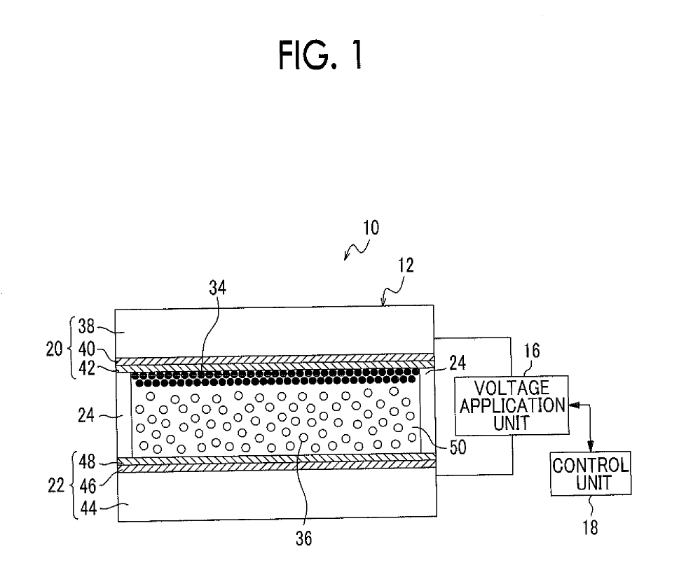

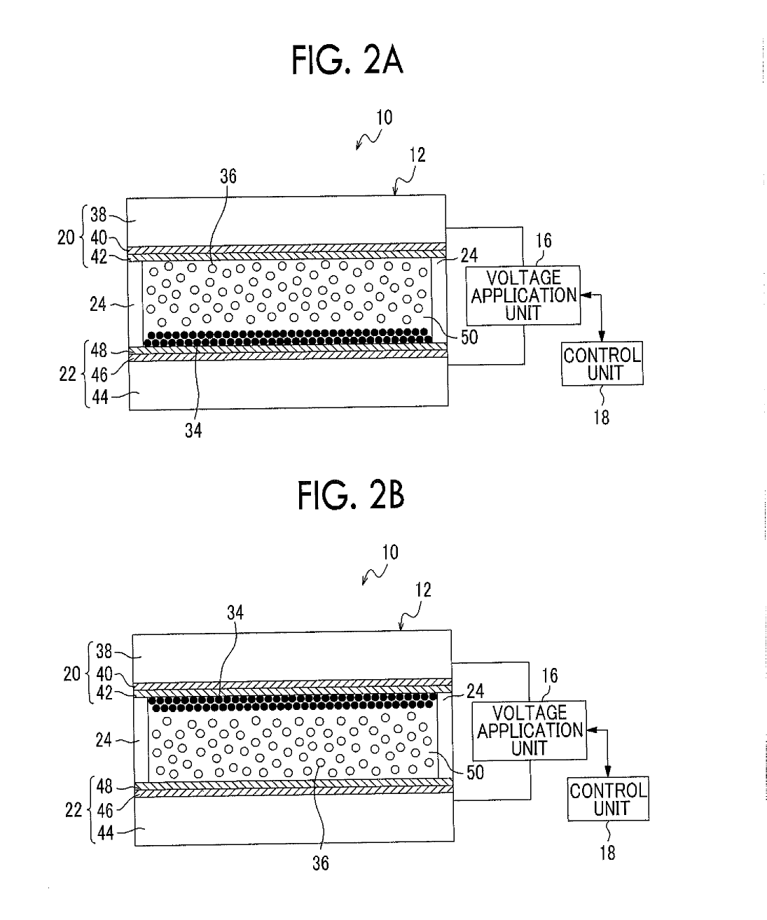

FIG. 1 is a schematic configuration diagram of the display device according to this exemplary embodiment. FIGS. 2A and 2B are explanatory views schematically illustrating a movement aspect of the particle group when a voltage is applied between the substrates of the display medium of the display device according to this exemplary embodiment.

Furthermore, in a display device 10 according to this exemplary embodiment, the particle dispersion for display according to this exemplary embodiment described above is applied as a particle dispersion including a dispersion medium 50 of a display medium 12, a particle group 34, and a reflective particle group 36. That is, in the display device 10 according to this exemplary embodiment, the electrophoretic particles as particles of the particle group 34 and the white particles for display according to this exemplary embodiment as particles of the reflective particle group 36 are dispersed in the dispersion medium 50.

As illustrated in FIG. 1, the display device 10 according to this exemplary embodiment includes the display medium 12, a voltage application unit 16 (for example, a power source) applying a voltage to the display medium 12, and a control unit 18.

The display medium 12 includes a display substrate 20 which is an image display surface, a back surface substrate 22 facing the display substrate 20 with a gap, a gap member 24 which maintains a space between the substrates at specific intervals and partitions the space between the display substrate 20 and the back surface substrate 22 into plural cells, and the reflective particle group 36 having an optical reflection property different from that of the particle group 34 enclosed in each cell.

The cell described above indicates a region surrounded by the display substrate 20, the back surface substrate 22, and the gap member 24. In the cell, the dispersion medium 50 is enclosed. The particle group 34 is configured of plural particles, is dispersed in the dispersion medium 50, and is moved between the display substrate 20 and the back surface substrate 22 according to electric field intensity formed in the cell through the gap of the reflective particle group 36.

Furthermore, the gap member 24 is disposed to correspond to each pixel at the time of displaying an image on the display medium 12, and the cell is formed to correspond to each of the pixels, and thus the display medium 12 may be configured to perform display of each of the pixels.

In addition, in this exemplary embodiment, in order to simplify the description, this exemplary embodiment will be described with reference to the drawing focused on one cell. Hereinafter, each configuration will be described in detail.

First, a pair of substrates will be described.

The display substrate 20 is configured by laminating a surface electrode 40 and a surface layer 42 on a support substrate 38 in this order. The back surface substrate 22 is configured by laminating a back surface electrode 46 and a surface layer 48 on a support substrate 44.

The display substrate 20, or both of the display substrate 20 and the back surface substrate 22 have translucency. Here, translucency in this exemplary embodiment indicates transmittance of visible light greater than or equal to 60%.

As a material of the support substrate 38 and the support substrate 44, glass or plastic, a polyethylene terephthalate resin, a polycarbonate resin, an acrylic resin, a polyimide resin, a polyester resin, an epoxy resin, a polyether sulfone resin, and the like are included.

As a material of the surface electrode 40 and the back surface electrode 46, oxides of indium, tin, cadmium, antimony, and the like, composite oxide such as ITO, metal such as gold, silver, copper, nickel, an organic material such as a polypyrrole or a polythiophene, and the like are included. The surface electrode 40 and the back surface electrode 46 may be any one of a single film, a mixed film, and a composite film of these materials. A thickness of the surface electrode 40 and the back surface electrode 46, for example, may preferably be from 100 Å to 2000 Å. The back surface electrode 46 and the surface electrode 40, for example, may be formed in the shape of a matrix or a stripe.

In addition, the surface electrode 40 may be embedded in the support substrate 38. In addition, the back surface electrode 46 may be embedded in the support substrate 44. In this case, the material of the support substrate 38 and the support substrate 44 is selected according to a composition of each of the particles of the particle group 34, and the like.

Furthermore, each of the back surface electrode 46 and the surface electrode 40 may be separated from the display substrate 20 and the back surface substrate 22, and thus may be arranged outside of the display medium 12.

Furthermore, in the above description, a case in which the electrodes (the surface electrode 40 and the back surface electrode 46) are provided in both of the display substrate 20 and the back surface substrate 22 is described, but the electrodes may be arranged in any one substrate to perform active matrix driving.

In addition, in order to perform the active matrix driving, the support substrate 38 and the support substrate 44 may include a thin film transistor (TFT) in each of the pixels. The TFT may be provided in the back surface substrate 22 but not in the display substrate.

Next, the surface layer will be described.

Each of the surface layer 42 and the surface layer 48 is formed on the surface electrode 40 and the back surface electrode 46. As a material configuring the surface layer 42 and the surface layer 48, a polycarbonate, a polyester, a polystyrene, a polyimide, epoxy, a polyisocyanate, a polyamide, polyvinyl alcohol, a polybutadiene, polymethylmethacrylate, copolyamide, an ultraviolet curing acrylic resin, a fluorine resin, and the like are included.

The surface layer 42 and the surface layer 48 may include the resins described above and a charge transporting material, and may include a self-supporting resin having a charge transporting property.

Next, the gap member will be described.

The gap member 24 for maintaining the gap between the display substrate 20 and the back surface substrate 22 is configured of a thermoplastic resin, a thermosetting resin, an electron beam curable resin, a photocurable resin, rubber, metal, and the like.

The gap member 24 may be integrated with any one of the display substrate 20 and the back surface substrate 22. In this case, the gap member 24 is prepared by an etching treatment etching the support substrate 38 or the support substrate 44, laser processing, press processing or printing processing using a mold which is prepared in advance, and the like.

In this case, the gap member 24 is prepared on any one of the display substrate 20 side and the back surface substrate 22 side, or on both sides.

The gap member 24 may be chromatic or achromatic, and may be achromatic and transparent, and in this case, the gap member 24 is configured of a transparent resin such as a polystyrene, a polyester or acryl, and the like.

In addition, it is preferable that the particulate gap member 24 be also transparent, and as the particulate gap member 24, glass particles are also used in addition to the transparent resin particles of a polystyrene, a polyester or acryl, and the like.

Furthermore, “transparent” indicates transmittance greater than or equal to 60% with respect to visible light.

Next, the reflective particle group will be described.

The reflective particle group 36 is configured of reflective particles having an optical reflection property different from that of the particle group 34, and functions as a reflective member displaying a color different from that of the particle group 34. Then, the reflective particle group 36 has a function as the gap member moving the particles without inhibiting the movement of the particles between the display substrate 20 and the back surface substrate 22. That is, each of the particles of the particle group 34 is moved from the back surface substrate 22 side to the display substrate 20 side, or from the display substrate 20 side to the back surface substrate 22 side through the gap of the reflective particle group 36.

Next, other configurations of the display medium will be described.

A size of the cell in the display medium 12 has a close relationship with resolution of the display medium 12, and the display medium 12 displaying an image with high resolution is able to be prepared as the cell becomes small, in general, a length of the display substrate 20 of the display medium 12 in a plate surface direction is approximately from 10 μm to 1 mm.

In order to adhere the display substrate 20 and the back surface substrate 22 to each other through the gap member 24, an adhering unit such as a combination of a bolt and a nut, a clamp, a clip and a frame for adhering a substrate is used. In addition, an adhering unit such as an adhesive agent, thermal fusion, and ultrasonic bonding may be also used.

As described above, the display device 10 according to this exemplary embodiment includes the display medium 12, the voltage application unit 16 applying a voltage to the display medium 12, and the control unit 18 (refer to FIG. 1).

The voltage application unit 16 is electrically connected to the surface electrode 40 and the back surface electrode 46. Furthermore, in this exemplary embodiment, a case where both of the surface electrode 40 and the back surface electrode 46 are electrically connected to the voltage application unit 16 is described, but one of the surface electrode 40 and the back surface electrode 46 may be grounded, and the other may be connected to the voltage application unit 16.

The voltage application unit 16 is connected to transfer a signal to the control unit 18.

The control unit 18 may be configured as a microcomputer including a central processing unit (CPU) managing an operation of the entire device, a random access memory (RAM) temporarily storing various data items, and a read only memory (ROM) storing various programs such as a control program controlling the entire device in advance.

The voltage application unit 16 is a voltage application device for applying a voltage to the surface electrode 40 and the back surface electrode 46, and a voltage according to the control of the control unit 18 is applied between the surface electrode 40 and the back surface electrode 46.

Next, a function of the display device 10 will be described. The function will be described according to an operation of the control unit 18.

Here, a case where the particle group 34 enclosed in the display medium 12 is charged with positive polarity will be described. In addition, a case where the dispersion medium 50 is transparent, and the reflective particle group 36 is white will be described. That is, in this exemplary embodiment, a case where the display medium 12 displays a color which is presented according to the movement of the particle group 34, and a white color due to the reflective particle group 36 is displayed as a background color will be described.

Furthermore, for description, an operation from a state where the particle group 34 is attached to the back surface substrate 22 side is described below.

First, an operational signal indicating that a voltage is applied for a specific period of time such that the surface electrode 40 becomes a negative electrode and the back surface electrode 46 becomes a positive electrode is output to the voltage application unit 16. From a state illustrated in FIG. 2A, the voltage applied between the electrodes increases, and when the surface electrode 40 is the negative electrode and a voltage greater than or equal to a threshold voltage at which a concentration variation is completed is applied, the particles configuring the particle group 34 charged with the positive electrode are moved to the display substrate 20 side in a state where an aggregation force of the particle group 34 decreases, and thus are led to the display substrate 20 (refer to FIG. 2B).

Then, when the application of the voltage between the electrodes is completed, the particle group 34 is restrained on the display substrate 20 side, and the color of the particle group 34 is viewed as the color of the display medium 12 which is viewed from the display substrate 20 side and the white color which is the color of the reflective particle group 36 is displayed as the background color.

Next, an operational signal indicating that a voltage is applied between the surface electrode 40 and the back surface electrode 46 for a specific period of time such that the surface electrode 40 becomes the positive electrode and the back surface electrode 46 becomes the negative electrode is output to the voltage application unit 16. The voltage applied between the electrodes increases, and when the surface electrode 40 is the positive electrode and the voltage greater than or equal to the threshold voltage at which the concentration variation is completed is applied, the particles configuring the particle group 34 charged with the positive electrode are moved to the back surface substrate 22 side in the state where the aggregation force of the particle group 34 decreases, and thus are led to the back surface substrate 22 (refer to FIG. 2A).

Then, when the application of the voltage between the electrodes is completed, the particle group 34 is restrained on the back surface substrate 22 side, and the white color of the reflective particle group 36 is viewed as the color of the display medium 12 which is viewed from the display substrate 20 side. Furthermore, the particle group 34 is shielded by the reflective particle group 36, and thus hardly viewed.

Here, a time for voltage application between the electrodes may be stored in a memory such as a RCM (not illustrated) in the control unit 18, or the like in advance as information indicating the voltage application time of voltage application during the operation. Then, at the time of executing processing, the information indicating the voltage application time may be read out.

Thus, in the display device 10 according to this exemplary embodiment, the particle group 34 reaches the display substrate 20 or the back surface substrate 22, and is attached or aggregated, and thus the display is performed.

Furthermore, in the display medium 12 and the display device 10 according to this exemplary embodiment described above, an aspect in which the surface electrode 40 is disposed in the display substrate 20 and the back surface electrode 46 is disposed in the back surface substrate 22, a voltage is applied between the electrodes (that is, between the substrates), and the particle group 34 is moved between the substrates, and thus the display is performed is described, but the invention is not limited thereto, and for example, may include an aspect in which the surface electrode 40 is disposed in the display substrate 20 and the electrode is disposed in the gap member, a voltage is applied between the electrodes, and the particle group 34 is moved between the display substrate 20 and the gap member, and thus the display is performed.

In addition, in the display medium 12 and the display device 10 according to this exemplary embodiment described above, an aspect in which one type (one color) of particle group is applied as the particle group 34 is described, but the invention is not limited thereto, and may include an aspect in which two or more types (two or more colors) of particle group are applied by using a combination of different charging polarity or the same charging polarity and a different threshold voltage (a voltage at which the electrophoretic particles start electrophoresis)

Specifically, for example, an aspect in which a first particle group having a positive charging property, a second particle group having a negative charging property, and a third particle group which has a positive charging property, a threshold voltage different from that of particles of the first particle group, and a large particle diameter are applied as the particle group 34 is included.

Electronic Device Including Display Medium (Display Device) and The Like

The display medium (the display device) according to this exemplary embodiment is provided in an electronic device, an exhibition medium, a card medium, and the like.

Specifically, the display medium (the display device) according to this exemplary embodiment, for example, is provided in an electronic bulletin board, an electronic circulation plate, an electronic blackboard, an electronic advertisement, an electronic signboard, a blinking sign, an electronic paper, an electronic newspaper, an electronic book, an electronic document sheet which is able to be shared with a copying machine and a printer, a portable computer, a tablet computer, a mobile phone, a smart card, a signature device, a watch, a shelf label, a flash drive, and the like in which an image is able to be maintained and rewritten.

### EXAMPLE

Hereinafter, the invention will be described in more detail with reference to Examples. Furthermore, unless otherwise specifically noted, a “part” and “%” indicate a weight basis.

### Example 1

### Surface Treatment of Titanium Oxide Particles

Titanium oxide particles (Maxlight “TS-01” manufactured by Showa Denko: a volume average particle diameter of 0.1 μm): 1 part by weight
3-methacroxy propyl trichlorosilane (Manufactured by Gelest Inc.): 0.5 parts by weight
Toluene (manufactured by Kanto Kagaku Co., Ltd.): 10 parts by weight

In the composition described above, each material is mixed, then 20 parts by weight of glass beads (φ1 mm) are added and dispersed by a rocking mill for 2 hours, and thus a surface treatment of the titanium oxide particles is performed (hereinafter, referred to as “surface treated titanium oxide particles”).

Synthesis of Silicone Polymer Dispersant
Silaplane FM-0721 (manufactured by JNC CO., LTD., weight-average molecular weight Mw=5000: the formula (1) [R¹=a methyl group, R^{1′}=a butyl group, m=68, and x=3]): 71 parts by weight
Styrene (manufactured by Wake Pure Chemical Industries, Ltd.): 28 parts by weight
Lauroyl peroxide (manufactured by Aldrich Co., Ltd.): 1.13 parts by weight
Toluene (manufactured by Kanto Kagaku Co., Ltd.): 20 parts by weight

In the composition described above, each material is mixed, and is reacted at 65° C. for 24 hours, then is precipitated and purified in ethanol (manufactured by Wako Pure Chemical Industries, Ltd.), and is dried, and thus a silicone polymer dispersant is obtained.

Preparation of White Particle dispersion (1)
Surface treated titanium oxide particles: 5 parts by weight
Polyolefin copolymer (ZEONEX 480 (manufactured by Nippon Zeon Co., Ltd.)): 20 parts by weight
Silicone polymer dispersant: 5 parts by weight
Tetrahydrofuran (THF): 75 parts by weight

The components described above are mixed, and thus a THE particle dispersion is obtained. Next, the obtained THE particle dispersion as a dispersed phase and silicone oil “KF-96L-2cs (manufactured by Shin-Etsu Chemical Co., Ltd.”) as a continuous phase are mixed at a weight ratio (the continuous phase: the dispersed phase) of 10:1, and are emulsified by a homogenizer, and thus an emulsified liquid is prepared.

Next, the obtained emulsified liquid is dried at 60° C. for 6 hours by an evaporator, and THE in the emulsified liquid is removed, and thus a white particle dispersion (1) where white particles (1) in which a surface of the titanium oxide particles is covered with the polyolefin copolymer are dispersed is obtained.

### Examples 2 to 8

White particle dispersions (2) to (8) are respectively obtained by the same method as that in Example 1 except that the type of polyolefin copolymer is changed according to Table 1.

### Comparative Example 1

### Preparation of White Particle Dispersion (C)

2-vinyl naphthalene (manufactured by Nippon Steel & Sumikin Chemical Co., Ltd.): 45 parts by weight
Silaplane FM-0721 (manufactured by JNC Co., Ltd., weight-average molecular weight Mw=5000: the formula (1) [R¹=a methyl group, R^{1′}=a butyl group, m=68, and x=3]): 45 parts by weight
Silicone oil (KF-96L-1cs: manufactured by Shin-Etsu Chemical Co., Ltd.): 240 parts by weight
Lauroyl peroxide (manufactured by Aldrich Co., Ltd.): 2.4 parts by weight

Each material described above is put into a flask, and is reacted at 75° C. for 24 hours. The obtained solution is subjected to centrifugal settling, a supernatent is removed, and 200 parts by weight of dimethyl silicone oil (KF-96L-2cs manufactured by Shin-Etsu Chemical Co., Ltd. viscosity 2cs) is added. The centrifugal settling is performed three times, a suspension liquid is subjected to a solvent substitution with dimethyl silicone oil, and a solid content of the particles is set to be greater than or equal to 40% by weight, and thus a white particle dispersion (C) is obtained.

Evaluation

The following evaluation is performed with respect to each of the obtained white particle dispersions. Here, each evaluation is performed immediately after preparation and after light irradiation. Results thereof are shown in Table 1.

Furthermore, the light irradiation is performed under the following condition. As a light irradiation device, Santest CPS+ (manufactured by ATLAS Co., Ltd.; a light source: a xenon air cooling lamp of 1500 W, radiant illumination of 100 klx, a black standard temperature of 42° C., a lamp filter: B (outdoor direct sunlight)) is used, and an irradiation time is 5 days. As a sample to be subjected to the light irradiation, the white particle dispersion having the solid content of the particles of 25% by weight of is dropped into a screw tubular bottle (Laboran 2cc, manufactured by As One Corporation) within a range from 0.1 g to 0.2 g. In the irradiation device, a sample bottle is horizontally arranged such that light is incident from an upper portion. Furthermore, the irradiation sample is covered with an ultraviolet light cutting film (TD60UL, a TAC film manufactured by Fuji Film Co., Ltd.)

Amount of Charge

Each of the white particle dispersions obtained in each Example is prepared such that the solid content of the particles is 25% by weight, then is enclosed between a pair of glass substrates attached with an indium-tin oxide (ITO) electrode (in a cell in which a spacer (the gap member) of 50 μm is disposed between a pair of ITO substrates) which are coated with a cytop as a spacer, and thus an element sample of which a display area is 2 cm×1 cm is prepared. Then, in the element sample, an amount of charge [C/cm²] is measured from a current amount when a rectangular wave of 30 V is applied by using 6515 SYSTEM ELECTROMETER (manufactured by KEITHLEY Co., Ltd.).

In order to coating the cytop, a solution of Cytop (manufactured by AGO Co., Ltd., CTL-809M): a diluted solution (CT-Solv.180)=1:2 (ratio by weight) is used. Then, 0.5 ml of the Cytop solution is dropped into the ITO substrate (5 cm×5 cm), a spin coat is performed with respect to the ITO substrate, then the ITO substrate is put into a decompression dryer and is dried at 120° C. for 2 hours.

TABLE 1

| | | | | Evaluation | |
|---|---|---|---|---|---|
| | | | | Charged | Charged |
| | White Particle dispersion | | | Amount | Amount |
| | | | White | Immediately | after |
| | | | Particle | after | Light |
| | | Type of Olefin | D50v | Preparation | Irradiation |
| | No | Copolymer | (nm) | (nC) | (nC) |
| Example 1 | (1) | ZEONEX 480 | 320 | 0.20 | 0.21 |
| | | (manufactured | | | |
| | | by Nippon Zeon | | | |
| | | Co., Ltd.) | | | |
| Example 2 | (2) | ZEONEX 480R | 350 | 0.31 | 0.31 |
| | | (manufactured | | | |
| | | by Nippon Zeon | | | |
| | | Co., Ltd.) | | | |
| Example 3 | (3) | ZEONEX E48R | 280 | 0.33 | 0.30 |
| | | (manufactured | | | |
| | | by Nippon Zeon | | | |
| | | Co., Ltd.) | | | |
| Example 4 | (4) | ZEONEX F52R | 300 | 0.12 | 0.14 |
| | | (manufactured | | | |
| | | by Nippon Zeon | | | |
| | | Co., Ltd.) | | | |
| Example 5 | (5) | ZEONEX 330R | 290 | 0.23 | 0.21 |
| | | (manufactured | | | |
| | | by Nippon Zeon | | | |
| | | Co., Ltd.) | | | |
| Example 6 | (6) | ZEONEX RS420 | 390 | 0.55 | 0.60 |
| | | (manufactured | | | |
| | | by Nippon Zeon | | | |
| | | Co., Ltd.) | | | |
| Example 7 | (7) | TOPAS 5013L-10 | 270 | 0.39 | 0.40 |
| | | (manufactured | | | |
| | | by Polyplastics | | | |
| | | Co., Ltd.) | | | |
| Example 8 | (8) | TOPAS 8007S-04 | 300 | 0.62 | 0.60 |
| | | (manufactured | | | |
| | | by Polyplastics | | | |
| | | Co., Ltd.) | | | |
| Comparative | (C) | None | 400 | 0.2 | 6 |
| Example 1 | | (Using Vinyl | | | |
| | | Naphthalene) | | | |

From the results described above, it is known that in Examples, a charged amount of the white particles in the white particle dispersion is small even after the light irradiation, compared to Comparative Example.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. White particles for display, comprising:
inorganic white particles; and
a covering layer that covers the inorganic white particles and includes a polymer obtained by polymerizing at least olefin as a constituent.

2. The white particles for display according to claim 1,
wherein the inorganic white particles are titanium oxide particles.

3. The white particles for display according to claim 1,
wherein the inorganic white particles are subjected to a surface treatment with a hydrophobizing agent.

4. The white particles for display according to claim 1,
wherein a surface of the covering layer is attached with or covered with a silicone polymer dispersant.

5. The white particles for display according to claim 4,
wherein a weight-average molecular weight of the silicone polymer dispersant is from 20000 to 100000.

6. The white particles for display according to claim 1,
wherein a volume average particle diameter of the white particles for display is from 0.1 μm to 10 μm.

7. The white particles for display according to claim 1,
wherein a covering amount of the covering layer with respect to the inorganic white particles is from 1% by weight to 99% by weight with respect to weight of the inorganic white particles.

8. A particle dispersion for display, comprising:
a white particle group including the white particles for display according to claim 1; and
a dispersion medium for dispersing the white particle group.

9. The particle dispersion for display according to claim 8, further comprising:
an electrophoretic particle group including electrophoretic particles that migrate according to an electric field.

10. A display device, comprising:
a display medium; and
an electric field forming unit that forms an electric field between the pair of substrates,
wherein the display medium includes:
a pair of substrates at least one of which has translucency;
an electrophoretic particle group that is enclosed between the pair of substrates, and includes electrophoretic particles that migrate according to an electric field;
a white particle group that is enclosed between the pair of substrates, and includes the white particles for display according to claim 1; and
a dispersion medium that is enclosed between the pair of substrates, and disperses the electrophoretic particle group and the white particle group.
